(19) United States
(12) Patent Application Publication
(10) Pub. No.: US 2023/0205226 A1
(43) Pub. Date: Jun. 29, 2023

(54) LOGISTICS TRANSPORT VEHICLE AND STRUCTURE FOR A CONSTRUCTION SITE LOGISTICS SYSTEM

(71) Applicant: LIEBHERR-WERK BIBERACH GMBH, Biberach an der Riss (DE)

(72) Inventors: Thorsten HESSELBEIN, Mittelbiberach (DE); Tobias SCHOLZ, Biberach (DE)

(21) Appl. No.: 17/999,704

(22) PCT Filed: May 21, 2021
(86) PCT No.: PCT/EP2021/063716

§ 371 Date: Nov. 22, 2022

(30) Foreign Application Priority Data
May 22, 2020 (DE) 10 2020 113 811.3

(51) Int. Cl. G05D 1/02; G06Q 50/28; G06Q 50/08

(52) U.S. Cl. CPC G05D 1/0276; G06Q 50/28; G06Q 50/08

(57) ABSTRACT

The invention relates to a logistics transport vehicle for a construction site logistics system for the automatic transport of construction materials and/or construction site equipment on a construction site grounds and/or from/to another location in the supply chain, comprising at least one self-driving main frame with running gear and a communication module for communicating with the construction site logistics system, wherein the main frame comprises at least one receptacle with connection means for exchangeably receiving and fastening at least one structure which is suitable for storing construction materials and/or construction equipment.

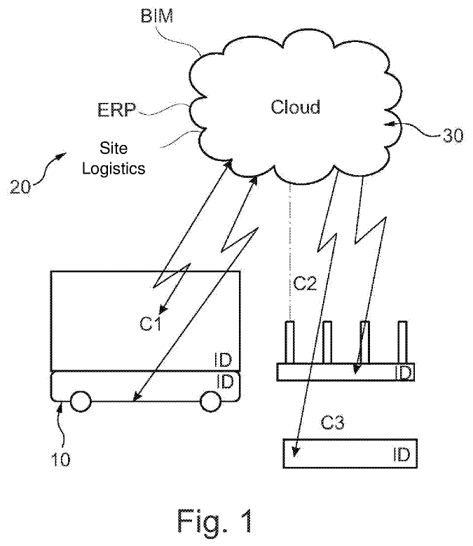

The invention relates to a logistics transport vehicle for a construction site logistics system for the automatic transport of construction materials and/or construction site equipment on a construction site.

On large construction sites, construction materials and construction equipment must often be transported back and forth between different places of use. One example is the transport of the construction materials and construction equipment from the place of delivery at the construction site to the place of use at the building. Such transport has to date been carried out manually using suitable transport vehicles such as excavators, trucks or lifting appliances. To date, a possibility of tracking the transport on the construction site and the subsequent use of construction materials and construction equipment has not been implemented and is technically difficult to achieve with the means available to date.

The present application therefore looks for ways of optimizing the aforementioned area of activity, in particular with regard to the logistics transport of construction materials and construction site equipment between different areas on the construction site.

This object is achieved by a logistics transport vehicle according to the features of claim 1. Advantageous embodiments of the logistics transport vehicle are the subject-matter of the dependent claims. Furthermore, the invention also relates to a structure for the storage of any construction materials and/or construction site equipment, which structure can be transported by means of the logistics transport vehicle. Finally, the invention also relates to a construction site logistics system comprising a plurality of logistics transport vehicles and structures which are to be coordinated by means of a system controller on the construction site.

The invention proposes a logistics transport vehicle which consists of a self-driving main frame with running gear. The running gear of the main frame is ideally electrically driven, but other drive variants are also conceivable. Furthermore, the main frame comprises a controller which permits an autonomous driving operation of the main frame on the construction site grounds or to another location in the supply chain. The autonomous driving operation of the main frame can be made possible completely by the integral controller of the main frame, but a distributed application is also conceivable in which the integral controller of the main frame interacts with at least one external server. The drive controller of the main device can also be completely located on the external server.

The main frame comprises at least one communication module for ideally bidirectional communication with a construction site logistics system which can optionally contain the external control server. The communication module is used to exchange any transport tasks and optionally control information for the autonomous driving operation.

According to the invention, the main frame also comprises at least one receptacle with connection means for exchangeably receiving and fastening at least one structure which is suitable for storing construction materials and/or construction equipment. As a result of this measure, the main frame can be fitted with different types of structures, making the main frame universally useable for different transport tasks or alternative tasks. In addition to different building materials, the transport of building equipment is possible. For example, corresponding structures could be kept ready at suitable loading stations and then merely need to be received by the main frame and driven to the target position. At such a target position, the structures can then be accepted and the main frame made available for the next transport order. The loading station does not have to be on the construction site; it is also conceivable that the loading station is at a supplier location or at the construction company's storage location and the delivery to the construction site takes place on the structure. This makes possible a continuous transport from e.g. the supplier to the place of use on the construction site without the unloading and reloading of goods.

Ideally, possible connection means are provided in the region of the receiving surface of the main frame and can be opened and closed automatically by means of a controller. Particularly preferred is the design of the connection means as a quick-release system, enabling an exchange or receiving of such a structure in as quick and uncomplicated manner as possible.

Against this background, it can also be advantageous if the running gear of the main frame is equipped with an automatic lowering mechanism in order to lower the running gear or the receiving surface of the main frame in the vertical direction. At reduced height, the main frame can then autonomously be displaced under the desired structure. Through subsequent raising of the running gear or the receiving surface, the structure which was driven under can be automatically received. Ideally, the quick-release system closes in a self-actuated manner in this context.

Furthermore, it can be provided that at least one reader is installed on the main frame in order to detect and optionally analyze an identification feature kept on the structure. By means of this measure, the main frame can uniquely identify the received structure. Such an identification feature is, for example, a suitable code which is attached to the structure. An alternative to this is electronically reading of a data store kept on the structure. The store can then also contain further information, such as the type and quantity of the received cargo.

In addition, the main frame can have a corresponding sensor system for detecting the surroundings, to thereby enable an autonomous displacement of the main frame. The sensor system can work optically. Other sensor types are also conceivable.

In addition to the claimed logistics unit, the present invention relates to a corresponding structure, which is suitable for being received by the claimed logistics transport vehicle. Such a structure can for example be provided with a loading surface for receiving different construction materials and/or construction equipment. It is also conceivable that a corresponding structure is provided with a handling unit, such as a robot, in order to perform different tasks at the target location. The structure can also be equipped with a measuring and/or sensor system in order to perform different measuring tasks at the target location. A prominent example of this is the monitoring of construction progress. The structure having a suitable measuring and/or sensor system is driven to the region of the building to be examined. The generated measurement and sensor data can be transmitted by means of the communication module to the construction site logistics system or another server.

If the structure is used to transport construction materials and/or construction equipment, the structure can preferably also be supplemented by an integral loading and unloading means, for example in the form of a loading crane. As a result, the structure can receive and/or unload construction materials or equipment without external aids.

It was already explained above that the logistics transport vehicle can be provided with a corresponding automatic lowering mechanism. Alternatively or in addition, the structure can have a suitable mechanism for a vertical movement of the structure. Conceivable here is a supporting apparatus, more particularly in the form of extensible or telescopic supporting feet, installed on the structure, as a result of which the main surface of the structure can be raised in the vertical direction and be driven under by the logistics transport vehicle.

The structure can usefully also be equipped with a lockable loading surface, and therefore the construction equipment or construction materials can be stored securely on the structure for a longer period of time in the sense of a logistics store. The lockable loading surface can be for example a lockable loading space, for example a container, which not only protects the contents against unauthorized access, but also offers additional protection against external environmental influences. As an alternative to the lockable loading space, securing means for fixing and subsequently securing picked-up construction materials and/or construction equipment can of course be provided.

The structure can, as already indicated above in relation to the logistics transport vehicle, have at least one identification feature, which can be detected or read by means of a suitable reader. The structure can also comprise an information store in which information for identifying the structure and additional information, for example about the type and quantity of load, target location etc., can be stored.

The structure can also be equipped with a sensor system for detecting and/or identifying the cargo. A corresponding sensor system can be a camera system, for example. It is also conceivable that by means of the sensor system, not only the type and extent of the cargo but also in particular changes to the load state can be automatically detected. It is conceivable that detected information can be sent via a communication module to a construction site system and/or stored in the provided information store.

The invention also relates to a combination of a logistics transport vehicle and at least one structure according to the invention.

The statements above relating to the logistics transport vehicle and the structure are necessary prerequisites for the structure of a claimed construction site logistics system, which is composed of at least one logistics transport vehicle and at least one structure according to the invention. The construction site logistics system is also supplemented by a central control server, which is communicatively connected with the logistics transport vehicles and/or the structures and is used to coordinate the system parts on the construction site. The server can also be implemented using a cloud-based solution.

Such a server is configured for example to communicate open transport orders to the transport units, which then process them accordingly. The server can also support the transport units during autonomous driving on the construction site by specifying corresponding travel routes. In addition, corresponding image processing, which may be needed for autonomous driving, can alternatively be moved to the server.

The server is preferably configured to transmit corresponding transport orders, which contain information about the required structure type and the corresponding loading station for receiving the structure or the construction materials or construction equipment to be transported. Based on these orders, the logistics transport vehicle can automatically head for the corresponding positions on the construction site and first head for the appropriate structure and then head for the loading station to receive the desired goods. Lastly, the logistics transport vehicles automatically drive to the desired target position.

The construction site logistics system can also have one or more interfaces in order to enable the connection to and integration in existing construction site systems in order to thus sufficiently realize a complete chain for the logistics beyond the boundaries of the construction site grounds.

Further advantages and properties of the invention are explained below based on the embodiment shown in the drawing. The single drawing briefly outlines the structure of such a construction site logistics system.

Core components of the construction site logistics system are the individual logistics transport vehicles 10, which are designed with a corresponding running gear for autonomous driving on the construction site. The transport vehicles 10 additionally comprise a receiving surface, on which different structures C1, C2, C3 can be received. The structure C1, for example, is designed in the form of a container with loading space. The structure C2 has a loading surface with vertical posts, while the structure C3 shows a simple loading plane. By means of the structures C1, C2, C3, different construction materials, for example stones, plasterboards, lightweight wall panels etc., can be received and transported. In addition, some structures C1, C2, C3 can be suitable for receiving appropriate construction equipment, for example, struts, shuttering and other small parts. Conceivable are also structures that are used less for the transport of goods and are instead equipped with a handling machine or sensor system for monitoring construction progress. In principle, any number of different structures for different purposes are conceivable.

The structures C1, C2 and C3 are fastened on the transport vehicle 10 by means of a quick-release system. At least some of the structures C1, C2, C3 comprise support feet by means of which the structure can be raised in the vertical direction to a height at which the logistics transport vehicle 10 can drive under it. The logistics transport vehicles 10 can also have an automatic lowering mechanism in order to enable their receiving surfaces to be lowered for the structures and to enable the logistics transport vehicles to drive under the structures C1, C2, C3.

The logistics transport vehicles 10 and the individual structures C1, C2, C3 can be linked with a central logistics center 20 via a radio interface, which is implemented via a cloud-based solution (Cloud 30) in the embodiment shown here. By means of software interfaces, the construction site logistics system can also be integrated in existing solutions such as BIM or ERP.

On the construction site, different loading and unloading stations are available, which the logistics transport vehicles 10 can automatically drive to. At the corresponding loading and unloading points, appropriate structures C1, C2, C3 can be received which have already been loaded with corresponding transport goods. Alternatively, the logistics transport vehicle can also receive an empty structure and then drive to a loading station in order to receive the transport goods suitable for the structure type.

The received transport goods or equipment are/is then autonomously driven by the logistics transport vehicle 10 to the desired target position. In the case of high-rise construction sites, such a target position can be a common tower, which has one or more elevator platforms for the subsequent vertical transport of the load.

The advantages of such a system are as follows:

Combination of horizontal and vertical transport in conjunction with a vertical conveying system (construction site elevator)

Independent driving in changing surroundings

Adoption of scan functions for the monitoring of construction progress

Logistics optimization for goods delivery at the place of installing or use

Integration of BIM/ERP/site logistics data

System also serves for transverse transport in a plane

Swarm system capability to increase payloads

1. A logistics transport vehicle for a construction site logistics system for the automatic transport of construction materials and/or construction site equipment on a construction site or from/to another location in the supply chain, comprising at least one self-driving main frame with running gear and a communication module for communicating with the construction site logistics system, wherein the main frame has at least one receptacle with connection means for exchangeably receiving and fastening at least one structure which is suitable for storing construction materials and/or construction equipment.

2. A logistics transport vehicle according to claim 1, wherein a quick-release system is provided as the connection means, wherein the release system can be preferably be automatically closed and/or opened by a controller of the main frame.

3. A logistics transport vehicle according to claim 1, wherein the running gear of the main frame comprises a lowering mechanism in order to enable an independent receiving and/or placing-down of the structure by means of a vertical movement of the main frame.

4. A logistics transport vehicle according to claim 1, wherein a reader is installed on the main frame in order to detect an identification feature kept on the structure and/or to read stored information.

5. A logistics transport vehicle according to claim 1, wherein the main frame comprises a sensor system for detecting the surroundings.

6. A structure for a logistics transport vehicle according to claim 1, wherein the structure comprises at least one loading surface for receiving building materials or building equipment and/or is equipped with a handling unit such as a robot and/or a measuring system or scanner for monitoring construction progress.

7. A structure according to claim 6, wherein the structure comprises its own loading and unloading crane.

8. A structure according to claim 6, wherein the at least one structure is designed with a supporting apparatus, in the form of extensible support feet, whose generated vertical movement of the structure permits an independent lifting and placing of the structure on the receiving surface of the main frame.

9. A structure according to claim 8, wherein the at least one structure comprises a lockable loading surface and/or is equipped with securing means for securing received construction materials and/or construction equipment.

10. A structure according to claim 6, wherein the structure comprises at least one identification feature or has an information store, containing stored identification information about the type of structure and/or cargo, which identification information can be read by means of a reader.

11. A structure according to claim 10, wherein a sensor system for detecting and/or identifying the cargo and/or for detecting changes to the loading is installed.

12. A unit of a logistics transport vehicle according to claim 1 and at least one structure for the logistics transport vehicle according, wherein the structure comprises at least one loading surface for receiving building materials or building equipment and/or is equipped with a handling unit such as a robot and/or a measuring system or scanner for monitoring construction progress.

13. A construction site logistics system comprising at least one logistics transport vehicle according to claim 1 and at least one structure for the logistics transport vehicle according, wherein the structure comprises at least one loading surface for receiving building materials or building equipment and/or is equipped with a handling unit such as a robot and/or a measuring system or scanner for monitoring construction progress, and further comprising a control server for coordinating the logistics transport vehicles, wherein the server is communicatively connected with the at least one logistics transport vehicle and/or the at least one structure.

14. A construction site logistics system according to claim 13, wherein the server is configured to transmit open transport orders to the logistics transport vehicles, wherein the orders contain information about the required structure type and/or the corresponding loading station for receiving the structure or the loading of the structure and the unloading point.

15. A construction site logistics system according to claim 14, wherein the construction site logistics system has an interface to at least one further electronic construction site system.
